(19) United States
(12) Patent Application Publication
(10) Pub. No.: US 2017/0185841 A1
(43) Pub. Date: Jun. 29, 2017

(54) METHOD AND ELECTRONIC APPARATUS FOR IDENTIFYING VIDEO CHARACTERISTIC

(71) Applicants: LE HOLDINGS (BEIJING) CO., LTD., Beijing (CN); LECLOUD COMPUTING CO., LTD., Beijing (CN)

(72) Inventors: Yang LIU, Beijing (CN); Wei WEI, Beijing (CN); Maosheng BAI, Beijing (CN); Yangang CAI, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/247,827

(22) Filed: Aug. 25, 2016

Related U.S. Application Data
(63) Continuation of application No. PCT/CN2016/088651, filed on Jul. 5, 2016.

(30) Foreign Application Priority Data
Dec. 29, 2015 (CN) 201511017505.X

(51) Int. Cl. G06K 9/00; G06K 9/62; G06F 17/30

(52) U.S. Cl. CPC G06K 9/00718; G06F 17/30858; G06F 17/30784; G06K 9/00744; G06K 9/6269

(57) ABSTRACT

Disclosed in the present disclosure is a method and an electronic apparatus for identifying video characteristic, wherein, the method includes the following steps: acquiring a video sample to be identified; extracting all key frames of the video sample; classifying the plurality of key frames of the video sample using a deep learning model; and determining whether the video to be identified is a salacious video according to a classification result. Therefore, videos regarding salacity could be identified in a video library. As a result, operating risks are reduced and financial and human resources are saved.

### CROSS REFERENCE TO RELATED APPLICATIONS

This application is a continuation of International Application No. PCT/CN2016/088651, filed on Jul. 5, 2016, which is based upon and claims priority to Chinese Patent Application No. 201511017505.X, titled as “method and device for identifying video characteristic” and filed on Dec. 29, 2015, the entire contents of which are incorporated herein by reference.

### TECHNICAL FIELD

The present disclosure relates to the field of videos of interconnection internet, and more specifically to a method and an electronic apparatus for identifying video characteristic.

### BACKGROUD

With the internet and technologies of multimedia developing rapidly, a plenty of videos are produced and spread via the internet. Some of the videos include illegal contents such as salacity or violence, etc. Effectively filtering out videos regarding salacity could significantly reduce the risk of involving salacity for companies of video websites.

A plenty of salacity videos are produced in the internet everyday. Currently, operators have to consume lots of human and financial resources to avoid the risks and the efficiency of human examination is low.

### SUMMARY

In the view of this, a method and an electronic apparatus for identifying video characteristics are provided in the present disclosure so that videos regarding salacity could be identified in a video library. As a result, operating risks are reduced and financial and human resources are saved.

A method for identifying a video characteristic is provided in one embodiment of the present application. The method comprises:

acquiring a video sample to be identified; extracting all key frames of the video sample;

classifying the key frames of the video sample using a deep learning model; and

determining whether the video to be identified is a salacious video according to a classification result.

In the present application, an electronic apparatus is provided including: at least one processor; and a memory; wherein, the memory stores a program which could be processed by the at least one processor, the instruction is executed by the at least one processor so that the at least one processor is capable of implementing any of the above methods for identifying video characteristic in the present application.

In one embodiment of the present application, a non-volatile computer storage medium is provided. The non-volatile computer storage medium stores computer-executable instructions. The computer-executable instructions are configured to implement any of the above methods for identifying video characteristic in the present application.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed. In the figures:

FIG. 1 is a flow chart of method for identifying video characteristic in one embodiment of the application;

FIG. 2 is a flow chart of a method for identifying video characteristic in one embodiment of the application;

FIG. 3 is a schematic diagram of a device for identifying video characteristic in one embodiment of the application; and

FIG. 4 is a schematic diagram of an electronic apparatus for implementing a method for identifying video characteristic in one embodiment of the application.

### DETAILED DESCRIPTION

The present application is illustrated by the following figures of accompanying drawings and embodiments whereby the implementation process of the technology of the present application for solving technical problems and achieving technical efficiency would be fully understood and implemented accordingly.

In a typical configuration, computing equipments include one or more processors, input/output interfaces and memories (or storages).

A memory may include a volatile memory of a computer readable medium, a random access memory (RAM) of a computer readable medium and/or a non-volatile memory of a computer readable medium such as a read-only memory (ROM) or a flash random access memory (flash RAM). The memory is one example of a computer readable medium.

A computer readable medium includes volatile memories or non-volatile memories. A mobile or non-mobile medium could execute information storages by any ways or technologies.

The information could be a computer readable instruction, a data structure, a program module or other data. The example of a storage medium of a computer includes but not limited to a phase-change memory (PRAM), a static random-access memory(SRAIVI), a dynamic random access memory (DRAM), other type of random access memory (RAM), a read-only memory (ROM), an electrically-erasable programmable read-only memory (EEPROM), a flash memory or other memory technology, a compact disc read-only memory (CD-ROM), a digital versatile disc (DVD) or other optical storage, a cassette magnetic tape, a magnetic tape data storage, other magnetic storage or other non-transmission medium used to store information which can be accessed by computing equipment. According to the present disclosure, the computer readable medium does not include a non-transitory media such as a data signal and a signal carrier.

As shown in the specification and claim, some terms are used to indicate some particular components. Persons having ordinary skills in the art could realize that different terms may be used to indicate one component. In the specification and claim, components will be distinguished according to their functions instead of their names. As mentioned in the specification and claim, “include” is an open term. Therefore “include” should be explained as “include but not limit”. “Approximately” means an acceptable tolerance scope. Persons having ordinary skills in the art are able to solve the said technical problems within the tolerance scope so that the technical effects could be reached. In addition to that, the term “couple” includes any direct and indirect electrical connections. Therefore, if the present disclosure indicates that a first device is couple to a second device, and then it is indicated that the first device is directly and electrically connected to the second device, or the first device is indirectly connected to the second device through other devices or ways. The descriptions in the following paragraphs are used to illustrate some embodiments of the present disclosure. However, the descriptions are just for illustrating the general principles of the present application and not for limiting the present application. The scope of the present application is defined according to what is claimed.

Note that the technical terms “include”, “comprise” or other variants are no-exclusive so that products or systems including a series of elements not only include the series of elements mentioned but also include elements other than the series of elements mentioned or inherent elements of the products or systems. Without limitations, elements defined by the sentence “include one . . . ” shall not exclusive of the products including the elements or the systems having other same elements.

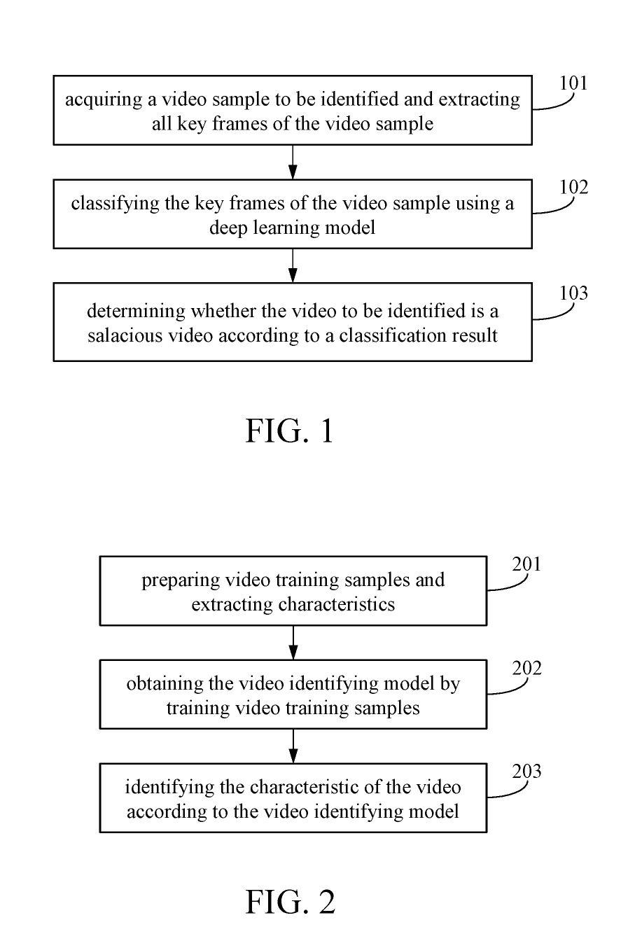

FIG. 1 is a flow chart of a method for identifying video characteristic in one embodiment. As shown in FIG. 1, the method includes:

In step 101, a video sample to be identified is acquired, and a plurality of key frames of the video sample is extracted.

Specifically, in step 101, the video sample is downloaded by resolving a video website for obtaining an address of the video sample by accessing a web crawler video webpage. The method for acquiring the video sample in the present application is not limited to the method in the above embodiment.

Because the number of the videos is huge and key frames represent picture frames of main content in the video, the amount of data of video index could be significantly reduced by selecting the key frames. Currently, methods for extracting key frames include lens-based methods, image features based methods, motion analysis based methods, cluster-based methods, and compressed domain based methods, etc. The method for extracting key frames in the present application is not limited to the methods mentioned above.

In step 102, the plurality of key frames of the video sample is classified through a deep learning model.

The deep learning model is formed by training a plenty of video training samples through convolutional neural network (CNN).

In step 103, it is determined whether the video to be identified is a salacious video according to the classification result.

Alternatively, when practically implemented, the step 103 includes:

When the classification result indicates a number of a plurality of key frames of the video sample regarding human figure is less than a first threshold of a number of the plurality of key frames of the video sample, it is determined the video to be identified is a non-figure video so that it is determined that the video to be identified is not the salacious video. The first threshold includes 20%.

When the classification result indicates the number of the plurality of key frames of the video sample regarding human figure is greater than or equal to 20% of the number of the plurality of key frames of the video sample, an input characteristic of each of the plurality of key frames of the video to be identified is dimensionally reduced so that four-dimensional input characteristics would be obtained. Each of the plurality of key frames of the video sample is detected according to the four-dimensional input characteristic of each of the plurality of key frames of the video sample and a video identifying model trained in advanced.

If a detection result indicates a number of a plurality of key frames of the video sample regarding salacity is greater than a second threshold of the number of the plurality of key frames of the video sample, it is determined the video to identified is the salacious video so that a warning label is provided. Otherwise, it is determined the video sample is not the salacious video. The second threshold includes 10%.

The video identifying model is obtained by a support vector machine (SVM) according to the input characteristic.

Alternatively, a formula corresponding to the video identifying model in one embodiment of the present application includes:

$$f ( x ) = sgn ( {\sum }_{i = 1}^{l} {α}_{i}^{*} {y}_{i} K ( x , {x}_{i} ) + {b}^{*} ) ;$$

wherein

$${α}^{*} = {( {α}_{1}^{*} , … , {α}_{l}^{*} )}^{T} ;$$

$${b}^{*} = {y}_{j} - {\sum }_{i = 1}^{l} {y}_{i} {α}_{i}^{*} K ( {x}_{i} , {x}_{j} ) .$$

In the above formula, a value of j is obtained by selecting a positive component 0<α*ⱼ<C from α*ⱼ, and K(xᵢ, * xⱼ) represents a kernel function

wherein a formula corresponding to the kernel function includes:

$$K ( {x}_{i} * {x}_{j} ) = exp ( - \frac{{‖ {x}_{i} - {x}_{j} ‖}^{2}}{2 {σ}^{2}} )$$

In the above formula, the initial value of a parameter σ of the kernel function is set as 1e-5, wherein 1e-5=0.00001.

C is a penalty parameter. The initial value of C is 0.1. εᵢ represents a slack variable corresponding to the i^{th} video sample. xᵢ represents a sample characteristic parameter corresponding to the i^{th} video sample. yᵢ represents a type of the i^{th} video sample. xⱼ represents a sample characteristic parameter corresponding to the j^{th} video sample. yⱼ represents a type of the j^{th} video sample. The parameter σ of the kernel function is an adjustable. l represents total number of the video samples. The symbol “∥ ∥” represents a norm.

The formula corresponding to a nonlinear soft margin classifier includes:

$${min}_{w , b} \frac{1}{2} {‖ w ‖}^{2} + c {\sum }_{i = 1}^{l} {ɛ}_{i} ;$$

subject to:

yᵢ((w×xᵢ+b))≧1−εᵢ, i=1, . . . , l

εᵢ≧0,i=1, . . . , l

C>0;

wherein the formula of a parameter w includes:

$$w = {\sum }_{i = 1}^{l} {y}_{i} {α}_{i} {x}_{i} ;$$

wherein the dual formula of the nonlinear soft margin classifier includes:

$${min}_{α} \frac{1}{2} {\sum }_{i = 1}^{l} {\sum }_{j = 1}^{l} {y}_{i} {y}_{j} {α}_{i} {α}_{j} K ( {x}_{i} , {x}_{j} ) - {\sum }_{j = 1}^{l} {α}_{j}$$

$$s . t . ;$$

$${\sum }_{i = 1}^{l} {y}_{i} {α}_{i} = 0$$

$$0 \leq {α}_{i} \leq C , i = 1 , … , l .$$

Alternatively, the video identifying model determines a best value of the parameter σ and a best value of the penalty parameter C using k-fold cross validation, wherein the number of fold k is 5. The penalty parameter C is set within a range of [0.01, 200]. The parameter σ of the kernel function is set within a range of [1e-6, 4]. A step length of the parameter σ of the kernel function and a step length of the penalty parameter C both are 2 during the verification process.

In the embodiments of the present application, the video sample to be identified is acquired and the plurality of key frames of the video sample is extracted. The plurality of key frames of the video sample is classified using the deep learning model. It is determined whether the video to be identified is a salacious video according to a classification result. Therefore, salacious videos will be automatically identified in a video library so that the operating risk is reduced and financial and human resources are saved.

Further, in the embodiments of the present application, the video identifying model determines a best value of the parameter a and a best value of the penalty parameter C using k-fold cross validation so that the accuracy of identifying video characteristics is ensured.

The present application is illustrated in detail by the following embodiments.

FIG. 2 is a flow chart of a method for identifying video characteristic in one embodiment of the present application. As shown in FIG. 2, the method includes:

In step 201, video training samples are prepared and characteristics are extracted.

In the present application, total 5000 videos training samples are prepared, wherein 2500 of them are positive samples (salacious videos) and 2500 of them are negative samples(non-salacious videos). The lengths of samples are random, and the contents of video training samples are random.

By analyzing positive and negative samples, it is indicated that the significant distinguishing characteristic between the positive samples and the negative samples is that most colors in the frames of the positive samples are skin colors, and the skin colors occupy a large area in the positive samples. Therefore, the significant distinguishing characteristic is used as the input characteristic in the embodiments of the present application.

For each of key frames of the video training samples, the dimension of the input space is expressed as n=width*height*2 when YUV420 format is used. In the formula, width and height respectively represent the width of the video frame and the height of the video frame. However, it more difficult to process for the data amount based on the previous formula. Therefore, the dimensional reduction is used in the embodiments of the present application:

For YUV420 or other types of formats of inputs, first of all, non-RGB color space is transformed to RBG color space.

The averages of pixels in each channel of R, B color spaces is calculated and labeled as ave_R, ave_G and ave_B.

The ratio of the number of plurality of pixels satisfying the formula (1) to the total number of plurality of pixels in the image is calculated and the ratio is labeled as c_R.

$$\{ \begin{matrix}R > 100 \&\& G > 40 \&\& B > 20 \\ R > G \&\& R > B\end{matrix} \qquad ( 1 )$$

In step 202, the video identifying model is obtained by training video training samples.

In the present application, video training samples are classified as two types of videos which are salacious videos and non-salacious videos. The input characteristics are labeled as ave_R, ave_G and ave_B which are totally four dimensions. The support vector machine (SVM) is a nonlinear soft margin classifier (C-SVC). The formula (2) corresponding to the nonlinear soft margin classifier (C-SVC) is expressed as:

$${min}_{w , b} \frac{1}{2} {‖ w ‖}^{2} + c {\sum }_{i = 1}^{l} {ɛ}_{i} ;$$

subject to:

yᵢ((w×xᵢ+b))≧1−εᵢ, i=1, . . . , l

εᵢ≧0,i=1, . . . , l

C>0 (2)

wherein the formula (3) of a parameter w in the formula (2) includes is expressed as:

$$w = {\sum }_{i = 1}^{l} {y}_{i} {α}_{i} {x}_{i} \qquad ( 3 )$$

the dual formula (4) of the nonlinear soft margin classifier in the formula (2) is expressed as:

$${min}_{α} \frac{1}{2} {\sum }_{i = 1}^{l} {\sum }_{j = 1}^{l} {y}_{i} {y}_{j} {α}_{i} {α}_{j} K ( {x}_{i} , {x}_{j} ) - {\sum }_{j = 1}^{l} {α}_{j} \\ s . t . ; \\ {\sum }_{i = 1}^{l} {y}_{i} {α}_{i} = 0 \\ 0 \leq {α}_{i} \leq C , i = 1 , … , l . \qquad ( 4 )$$

wherein K(xᵢ,xⱼ) represents a kernel function. The kernel function in the embodiments of the present application is the radial basis function kernel (RBF). The formula (5) of the kernel function is expressed as:

$$K ( {x}_{i} * {x}_{j} ) = exp ( - \frac{{‖ {x}_{i} - {x}_{j} ‖}^{2}}{2 {σ}^{2}} ) \qquad ( 5 )$$

In the above embodiment, C represents a penalty parameter, εᵢ represents a slack variable corresponding to the i^{th} video sample, xᵢ represents a sample characteristic parameter corresponding to the i^{th} video sample, yᵢ represents a type of the i^{th} video sample (the i^{th} video is a salacious video or non-salacious video, for example, 1 could be set as a salacious video and −1 could be set as a non-salacious video), xⱼ represents a sample characteristic parameter corresponding to the j^{th} video sample, and yⱼ represents a type of the j^{th} video sample. The parameter σ of is an adjustable parameter of the kernel function, l represents total number of the video samples, the symbol “∥ ∥” represents a norm.

According to the above formula (2) to formula (5), the best solution of the formula (4) could be obtained. As shown in formula (6) expressed as:

α*=(α*₁, . . . , α*ₗ)^{T} (6)

According to α*, b* could be obtained by calculating via the formula (7) expressed as:

$${b}^{*} = {y}_{i} - {\sum }_{i = 1}^{l} {y}_{i} {α}_{i}^{*} K ( {x}_{i} , {x}_{j} ) \qquad ( 7 )$$

In the formula (7), a value of j is obtained by selecting a positive component 0<α*ⱼ<C from α*ⱼ.

The initial value of the aforementioned penalty parameter C is set as 0.1. The initial value of the parameter σ of the kernel function (RBF) is set as 1e-5, wherein 1e-5=0.00001.

Secondly, according to the parameter α* and b*, the video identifying model could be obtained in the formula (8) expressed as:

$$f ( x ) = sgn ( {\sum }_{i = 1}^{l} {α}_{i}^{*} {y}_{i} K ( x , {x}_{i} ) + {b}^{*} ) \qquad ( 8 )$$

Moreover, in order to increase the generalization ability of the training model, a best value of the parameter σ and a best value of the penalty parameter C are searched using k-fold cross validation for the video identifying model in the embodiments of the present application. For example, the number of fold k could be set as 5. The penalty parameter C is set as within the range of [0.01, 200]. The parameter σ of the kernel function is set within a range of [1e-6, 4]. A step length of the parameter σ of the kernel function and a step length of the penalty parameter C both are 2 during the verification process.

In step 203, the characteristic of video is identified according to the video identifying model.

For the video sample to be identified, first of all, all key frames of the video are extracted. Then all key frames are classified using the deep model (Alexnet). When the detection result indicates a number of a plurality of key frames of the video regarding human figure is less than 20% of the number of the plurality of key frames of the video sample, it is determined the video is a non-human figure video so that it is determined the video is not the salacious video. Otherwise, the input characteristics of input all key frames are dimensionally reduced so that four-dimensions input characteristics such as ave_R, ave ave_B and c_R are obtained. Then through the four-dimensions input characteristics and the video identifying model (e.g., the formula (8)) obtained by training, each key frame of the video is detected. If the detection result indicates a number of a plurality of key frames of the video sample regarding salacity is greater than 10% of the number of the plurality of key frames of the video sample, it is determined the video is the salacious video so that a warning label is provided, otherwise, it is determined the video is not the salacious video.

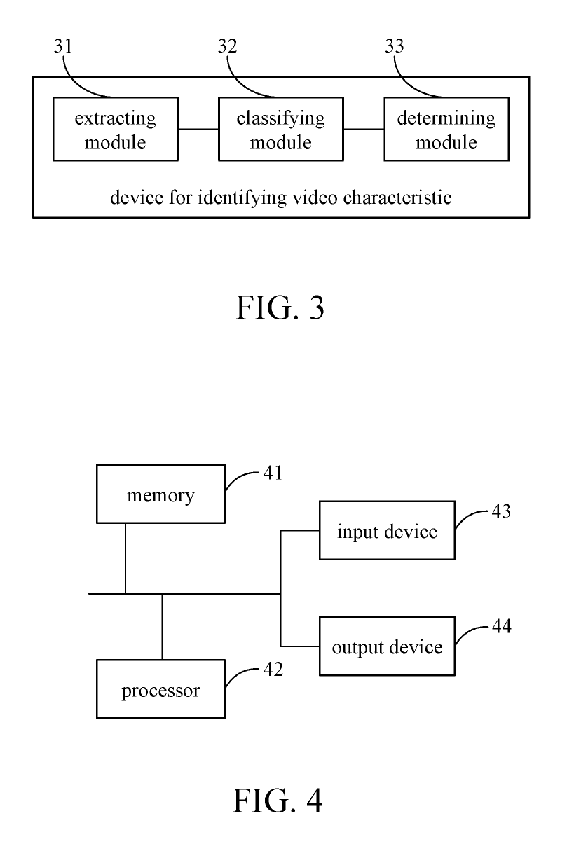

FIG. 3 is a schematic diagram of a device for identifying video characteristic in one embodiment. As shown in FIG. 3, the device includes:

an extracting module 31 configured to acquire a video sample to be identified and extract a plurality of key frames of the video sample;

a classifying module 32 configured to classify the plurality of key frames of the video sample using a deep learning model; and

a determining module 33 configured to determine whether the video to be identified is a salacious video according to a classification result.

Alternatively, the determining module 33 is specifically configured to:

determine the video to be identified is a non-figure video so that it is determined that the video to be identified is not the salacious video when the classification result indicates a number of a plurality of key frames of the video sample regarding human figure is less than a first threshold of a number of the plurality of key frames of the video sample. The first threshold includes 20%.

The determining module 33 is specifically configured to:

dimensionally reduce a input characteristic of each of the plurality of key frames of the video to be identified so that four-dimensional input characteristics are obtained when the classification result indicates the number of the plurality of key frames of the video sample regarding human figure is greater than or equal to 20% of the number of the plurality of key frames of the video sample.

Through the 4-dimensional input characteristics and the video identifying model trained in advanced, each of key frames of the video to be identified is detected.

If a detection result indicates a number of a plurality of key frames of the video sample regarding salacity is greater than a second threshold of the number of the plurality of key frames of the video sample, it is determined the video to identified is the salacious video so that a warning label is provided, otherwise, it is determined the video sample is not the salacious video. The second threshold includes 10%.

The deep learning model is formed by training a plenty of video training samples through convolutional neural network (CNN).

The video identifying model is obtained by a support vector machine according to the input characteristics.

Alternatively, a formula corresponding to the video identifying model includes:

$$f ( x ) = sgn ( {\sum }_{i = 1}^{l} {α}_{i}^{*} {y}_{i} K ( x , {x}_{i} ) + {b}^{*} ) ;$$

wherein

$${α}^{*} = {( {α}_{1}^{*} , … , {α}_{l}^{*} )}^{T} ;$$

$${b}^{*} = {y}_{j} - {\sum }_{i = 1}^{l} {y}_{i} {α}_{i}^{*} K ( {x}_{i} , {x}_{j} ) ;$$

wherein a value of j is obtained by selecting a positive component 0<α*ⱼ<C from α*ⱼ, and K(xᵢ*xⱼ) represents a kernel function.

wherein a formula corresponding to the kernel function is expressed as:

$$K ( {x}_{i} * {x}_{j} ) = exp ( - \frac{{‖ {x}_{i} - {x}_{j} ‖}^{2}}{2 {σ}^{2}} ) ;$$

wherein the initial value of a parameter σ of the kernel function is set as 1e-5, wherein 1e-5=0.00001.

C is a penalty parameter and the initial value of C is 0.1. εᵢ represents a slack variable corresponding to the i^{th} video sample. xᵢ represents a sample characteristic parameter corresponding to the i^{th} video sample. yᵢ represents a type of the i^{th} video sample. xⱼ represents a sample characteristic parameter corresponding to the j^{th} video sample. yⱼ represents a type of the j^{th} video sample. The parameter σ of the kernel function is an adjustable. l represents total number of the video samples. The symbol “∥ ∥” represents a norm.

The formula corresponding to a nonlinear soft margin classifier includes:

$${min}_{w , b} \frac{1}{2} {‖ w ‖}^{2} + c {\sum }_{i = 1}^{l} {ɛ}_{i} ;$$

subject to:
yᵢ((w×xᵢ+b))≧1−εᵢ,i=1, . . . , l

εᵢ≧0,i=1, . . . , l

C>0;

wherein the formula of a parameter w includes:

$$w = {\sum }_{i = 1}^{l} {y}_{i} {α}_{i} {x}_{i} ;$$

wherein the dual formula of the nonlinear soft margin classifier includes:

$${min}_{α} \frac{1}{2} {\sum }_{i = 1}^{l} {\sum }_{j = 1}^{l} {y}_{i} {y}_{j} {α}_{i} {α}_{j} K ( {x}_{i} , {x}_{j} ) - {\sum }_{j = 1}^{l} {α}_{j}$$

$$s . t . \text{:}$$

$${\sum }_{i = 1}^{l} {y}_{i} {α}_{i} = 0$$

$$0 \leq {α}_{i} \leq C , i = 1 , … , l ;$$

The video identifying model determines a best value of the parameter σ and a best value of the penalty parameter C using k-fold cross validation, wherein the number of k is 5.The penalty parameter C is set within a range of [0.01, 200]. The parameter σ of the kernel function is set within a range of [1e-6, 4]. A step length of the parameter σ of the kernel function and a step length of the penalty parameter C both are 2 during the verification process.

The device shown in FIG. 3 could implement the methods shown in FIG. 1 and FIG. 2. The fundamental of implementing the device and the effects of the technology of the device are not repeated here.

In one embodiment of the present application, a non-volatile computer storage medium is provided. The non-volatile computer storage medium stores computer-executable instructions. The computer-executable instructions are capable of implementing any of above methods for identifying video characteristic in the embodiments.

FIG. 4 is a schematic diagram of an electronic apparatus for implementing a method for identifying video characteristic in one embodiment of the present application. As shown in FIG. 4, the electronic apparatus includes a memory 41 and one or more processors 42, wherein:

The memory 41 stores a program which could be executed by the at least one processor 42. The instruction is executed by the at least one processor 42 so that the at least one processor 42 is capable of implementing:

Acquiring a video sample to be identified, extracting all key frames of the video sample, classifying the key frames of the video sample using a deep learning model, and determining whether the video to be identified is a salacious video according to a classification result.

Specifically, the processor 42 is configured to determine the video to be identified is a non-figure video so that it is determined that the video to be identified is not the salacious video when the classification result indicates a number of a plurality of key frames of the video sample regarding human figure is less than a first threshold of a number of the plurality of key frames of the video sample.

Further, the processor 42 is configured to dimensionally reduce a input characteristic of each of the plurality of key frames of the video to be identified when the classification result indicates the number of the plurality of key frames of the video sample regarding human figure is greater than or equal to the first threshold of the number of the plurality of key frames of the video sample. The processor is configured to detect each of the plurality of key frames of the video sample through the dimensionally reduced input characteristic of each of the plurality of key frames of the video sample and a video identifying model trained in advanced. The processor is configured to determine the video to identified is the salacious video so that a warning label is provided, otherwise, determining the video sample is not the salacious video if a detection result indicates a number of a plurality of key frames of the video sample regarding salacity is greater than a second threshold of the number of the plurality of key frames of the video sample.

Specifically, the video identifying model is obtained by a support vector machine according to the input characteristic processed.

A formula corresponding to the video identifying model is expressed as:

$$f ( x ) = sgn ( {\sum }_{i = 1}^{l} {α}_{i}^{*} {y}_{i} K ( x , {x}_{i} ) + {b}^{*} ) ;$$

wherein

$${α}^{*} = {( {α}_{1}^{*} , … , {α}_{l}^{*} )}^{T} ;$$

$${b}^{*} = {y}_{j} - {\sum }_{i = 1}^{l} {y}_{i} {α}_{i}^{*} K ( {x}_{i} , {x}_{j} ) ;$$

wherein a value of j is obtained by selecting a positive component 0<α*ⱼ<C from α*ⱼ, and K(xᵢ*xⱼ) represents a kernel function.

wherein a formula corresponding to the kernel function is expressed as:

$$K ( {x}_{i} * {x}_{j} ) = exp ( - \frac{{‖ {x}_{i} - {x}_{j} ‖}^{2}}{2 {σ}^{2}} ) ;$$

wherein the initial value of a parameter σ of the kernel function is set as 11e-5.

C is a penalty parameter, the initial value of C is 0.1. εᵢ represents a slack variable corresponding to the i^{th} video sample. xᵢ represents a sample characteristic parameter corresponding to the i^{th} video sample. yᵢ represents a type of the i^{th} video sample. xⱼ represents a sample characteristic parameter corresponding to the j^{th} video sample. yⱼ represents a type of the j^{th} video sample. The parameter σ of the kernel function is a adjustable. l represents total number of the video samples, the symbol “∥ ∥” represents a norm.

The formula corresponding to a nonlinear soft margin classifier is expressed as:

$${min}_{w , b} {‖ w ‖}^{2} + c {\sum }_{i = 1}^{l} {ɛ}_{i} ;$$

subject to:

yᵢ((w×xᵢ+b))≧1−εᵢ,i=1, . . . , l

εᵢ≧0,i=1, . . . , l

C>0;

wherein the formula of a parameter w includes:

$$w = {\sum }_{i = 1}^{l} {y}_{i} {α}_{i} {x}_{i} ;$$

the dual formula of the nonlinear soft margin classifier includes:

$${min}_{α} \frac{1}{2} {\sum }_{i = 1}^{l} {\sum }_{j = 1}^{l} {y}_{i} {y}_{j} {α}_{i} {α}_{j} K ( {x}_{i} , {x}_{j} ) - {\sum }_{j = 1}^{l} {α}_{j}$$

$$s . t . \text{:}$$

$${\sum }_{i = 1}^{l} {y}_{i} {α}_{i} = 0$$

$$0 \leq {α}_{i} \leq C , i = 1 , … , l$$

Specifically, the video identifying model determines a best value of the parameter σ and a best value of the penalty parameter C using k-fold cross validation, wherein the number of fold k is 5. The penalty parameter C is set within a range of [0.01, 200]. The parameter σ of the kernel function is set within a range of [1e-6, 4]. A step length of the parameter σ of the kernel function and a step length of the penalty parameter C both are 2 during the verification process.

The technical solutions and the functional characteristics and connections of each module in the device are the same as in the embodiments of FIG. 1 to FIG. 3. Please refer to the aforementioned embodiments of FIG. 1 to FIG. 3 if it is inadequate.

The electronic apparatus used for implementing the method for identifying video characteristic can further include: an input device 43 and an output device 44.

The memory 41, the processor 42, the input device 43 and the output device 44 could be connected to each other via a bus or other members for connection. In FIG. 4, they are connected via the bud in the embodiment.

The memory 41 is one kind of non-volatile computer-readable storage mediums applicable to store non-volatile software programs, non-volatile computer-executable programs and modules; for example, the program instructions and the function modules (the extracting module 31, the classifying module 32 and the determining module 33 in FIG. 3) corresponding to the method for identifying video characteristic in the embodiments are respectively a computer-executable program and a computer-executable module. The processor 42 executes function applications and data processing of the server by running the non-volatile software programs, non-volatile computer-executable programs and modules stored in the memory 41, and thereby the methods for identifying video characteristic in the aforementioned embodiments are achievable.

The memory 41 can include a program storage area and a data storage area, wherein the program storage area can store an operating system and at least one application program required for a function; the data storage area can store data created according to the usage of a processing apparatus operated in list items. Furthermore, the memory 41 can include a high speed random-access memory, and further include a non-volatile memory such as at least one disk storage member, at least one flash memory member, and other non-volatile solid-state memory member. In some embodiments, the memory 41 can have a remote connection with the processor 42, and such memory can be connected to the device for adjusting image quality of video by a network. The aforementioned network includes, but not limited to, internet, intranet, local area network, mobile communication network and combination thereof.

The input device 43 can receive digital or character information, and generate a key signal input regarding a user setup of the device for adjusting image quality of video and a function control. The output device 44 can include a displaying unit such as screen.

The one or more modules are stored in the memory 41. When the one or more modules are executed by one or more processor 42, the method for identifying video characteristic is performed.

The aforementioned product can execute the method provided by the embodiments of the present application and have a block module and benefits corresponding to the executing method. Technical details not described clearly in the embodiment can be found in the method provided by the embodiments of the present application.

The electronic apparatus in the embodiments of the present application may be presence in many forms including, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The embodiments of the device described above are just exemplary, wherein the units described as separate components could be or could not be physically separated from each other. The components used as units could be or could not be physical units. The components could be located in one place or could be spread over multiple network elements. According to the actual demand, part of modules or all modules can be selected to achieve the purpose of the embodiments of the present disclosure. Persons having ordinary skills in the art could realize and implement the embodiments of the present disclosure without providing creative efforts.

Through the above descriptions of embodiments, those skilled in the art can clearly realize each embodiment can be implemented using software plus essential common hardware platforms. Certainly each embodiment can be implemented using hardware. Based on the understanding, the above technical solutions or part of the technical solutions contributing to the prior art could be embodied in form of software products. The computing software products can be stored in a computer-readable storage medium such as ROM/RAM, disk, compact disc, etc. The computing software products include several instructions configured to make a computing device (a personal computer, a server, or internet device, etc) carry out the methods in each embodiments or part of methods in the embodiments.

Finally, it should be noted that: the above embodiments are just used for illustrating the technical solutions of the present application and not for limiting the present application. Even though the present application is illustrated clearly referring to the previous embodiments, persons having ordinary skills in the art should realize the technical solutions described in the aforementioned embodiments can be modified or part of technical features can be displaced equivalently. The modification or the displacement would not make corresponding essentials of the technical solutions out of spirit and scope of the technical solution of each embodiment of the present application.

What is claimed is:

1. A method for identifying a video characteristic, comprising:
acquiring a video sample to be identified;
extracting all key frames of the video sample;
classifying the key frames of the video sample using a deep learning model; and
determining whether the video to be identified is a salacious video according to a classification result.

2. The method according to claim 1, wherein the determining whether the video to be identified is the salacious video according to the classification result comprises:
determining the video to be identified is a non-figure video so that it is determined that the video to be identified is not the salacious video, if the classification result indicates that a number of the key frames of the video sample regarding human figure is less than a first threshold of a number of the key frames of the video sample.

3. The method according to claim 1, wherein the determining whether the video to be identified is the salacious video according to the classification result comprises:
dimensionally reducing input characteristics of all the key frames of the video to be identified, if the classification result indicates the number of the key frames of the video sample regarding human figure is greater than or equal to the first threshold of the number of the key frames of the video sample;
detecting each key frame of the video sample through the dimensionally reduced input characteristic of each key frame of the video sample and a video identifying model trained in advanced; and
determining the video to identified is the salacious video so that a warning label is provided, if a detection result indicates a number of the key frames of the video sample regarding salacity is greater than a second threshold of the number of the key frames of the video sample, otherwise, determining the video sample is not the salacious video.

4. The method according to claim 3, wherein the video identifying model is obtained by a support vector machine according to the input characteristic, and a formula corresponding to the video identifying model is expressed as:
$$f ( x ) = sgn ( {\sum }_{i = 1}^{l} {α}_{i}^{*} {y}_{i} K ( x , {x}_{i} ) + {b}^{*} ) ;$$
wherein
$${α}^{*} = {( {α}_{1}^{*} , … , {α}_{l}^{*} )}^{T} ;$$
$${b}^{*} = {y}_{j} - {\sum }_{i = 1}^{l} {y}_{i} {α}_{i}^{*} K ( {x}_{i} , {x}_{j} ) ;$$
a value of j is obtained by selecting a positive component 0<α*ⱼ<C from α*ⱼ, and K(xᵢ*xⱼ) represents a kernel function, wherein a formula corresponding to the kernel function is expressed as:
$$K ( {x}_{i} * {x}_{j} ) = exp ( - \frac{{‖ {x}_{i} - {x}_{j} ‖}^{2}}{2 {σ}^{2}} ) ;$$
an initial value of a parameter a of the kernel function is set as 1e-5;
wherein C is a penalty parameter, the initial value of C is 0.1, εᵢ represents a slack variable corresponding to the i^{th} video sample, xᵢ represents a sample characteristic parameter corresponding to the i^{th} video sample, yᵢ represents a type of the i^{th} video sample, xⱼ represents a sample characteristic parameter corresponding to the i^{th} video sample, yⱼ represents a type of the j^{th} video sample, the parameter σ of the kernel function is an adjustable function, l represents total number of the video samples, the symbol “∥ ∥” represents a norm, and the formula corresponding to a nonlinear soft margin classifier is expressed as:
$${min}_{w , b} \frac{1}{2} {‖ w ‖}^{2} + c {\sum }_{i = 1}^{l} {ɛ}_{i} ;$$
subject to:
yᵢ((w×xᵢ+b))≧1−εᵢ,i=1, . . . , l
εᵢ≧0,i=1, . . . , l
C>0;
wherein the formula of a parameter w comprises:
$$w = {\sum }_{i = 1}^{l} {y}_{i} {α}_{i} {x}_{i} ;$$
a dual formula of the nonlinear soft margin classifier comprises:
$${min}_{α} \frac{1}{2} {\sum }_{i = 1}^{l} {\sum }_{j = 1}^{l} {y}_{i} {y}_{j} {α}_{i} {α}_{j} K ( {x}_{i} , {x}_{j} ) - {\sum }_{j = 1}^{l} {α}_{j}$$
$$s . t . \text{:}$$
$${\sum }_{i = 1}^{l} {y}_{i} {α}_{i} = 0$$
$$0 \leq {α}_{i} \leq C , i = 1 , … , l$$

5. The method according to claim 4, wherein the video identifying model determines a best value of the parameter σ and a best value of the penalty parameter C using k-fold cross validation, a number of k is 5, the penalty parameter C is set within a range of [0.01, 200], the parameter σ of the kernel function is set within a range of [1e-6, 4], and a step length of the parameter σ of the kernel function and a step length of the penalty parameter C both are 2.

6. A non-volatile computer storage medium storing computer-executable instructions, the computer-executable instructions set as:
acquiring a video sample to be identified;
extracting all key frames of the video sample;
classifying the key frames of the video sample using a deep learning model; and
determining whether the video to be identified is a salacious video according to a classification result.

7. The non-volatile computer storage medium according to claim 6, the determining whether the video to be identified is the salacious video according to the classification result comprises:
determining the video to be identified is a non-figure video so that it is determined that the video to be identified is not the salacious video, if the classification result indicates that a number of the key frames of the video sample regarding human figure is less than a first threshold of a number of the key frames of the video sample.

8. The non-volatile computer storage medium according to claim 6, the determining whether the video to be identified is the salacious video according to the classification result comprises:
dimensionally reducing input characteristics of all the key frames of the video to be identified if the classification result indicates the number of the key frames of the video sample regarding human figure is greater than or equal to the first threshold of the number of the key frames of the video sample;
detecting each frame of the video sample through the dimensionally reduced input characteristic of each key frame of the video sample and a video identifying model trained in advanced; and
determining the video to identified is the salacious video so that a warning label is provided, if a detection result indicates a number of the key frames of the video sample regarding salacity is greater than a second threshold of the number of the plurality of key frames of the video sample, otherwise, determining the video sample is not the salacious video.

9. The non-volatile computer storage medium according to claim 8, wherein the video identifying model is obtained by a support vector machine according to the input characteristic processed, and a formula corresponding to the video identifying model is expressed as:
$$f ( x ) = sgn ( {\sum }_{i = 1}^{l} {α}_{i}^{*} {y}_{i} K ( x , {x}_{i} ) + {b}^{*} ) ;$$
wherein
$${α}^{*} = {( {α}_{1}^{*} , … , {α}_{l}^{*} )}^{T} ;$$
$${b}^{*} = {y}_{j} - {\sum }_{i = 1}^{l} {y}_{i} {α}_{i}^{*} K ( {x}_{i} , {x}_{j} ) ;$$
a value of j is obtained by selecting a positive component 0 <α*ⱼ<C from α*ⱼ, and K(xᵢ* xⱼ) represents a kernel function, wherein a formula corresponding to the kernel function is expressed as:
$$K ( {x}_{i} * {x}_{j} ) = exp ( - \frac{{‖ {x}_{i} - {x}_{j} ‖}^{2}}{2 {σ}^{2}} ) ;$$
an initial value of a parameter σ of the kernel function is set as 1e-5;
wherein C is a penalty parameter, the initial value of C is 0.1, εᵢ represents a slack variable corresponding to the i^{th} video sample, xᵢ represents a sample characteristic parameter corresponding to the i^{th} video sample, yᵢ represents a type of the i^{th} video sample, x₁ represents a sample characteristic parameter corresponding to the i^{th} video sample, yⱼ represents a type of the j^{th} video sample, the parameter a of the kernel function is an adjustable function, l represents total number of the video samples, the symbol “∥ ∥” represents a norm, and the formula corresponding to a nonlinear soft margin classifier is expressed as:
$${min}_{w , b} \frac{1}{2} {‖ w ‖}^{2} + c {\sum }_{i = 1}^{l} {ɛ}_{i} ;$$
subject to:
yᵢ((w×xᵢ+b))≧1−εᵢ,i=1, . . . , l
εᵢ≧0,i=1, . . . , l
C>0;
wherein the formula of a parameter w comprises:
$$w = {\sum }_{i = 1}^{l} {y}_{i} {α}_{i} {x}_{i} ;$$
a dual formula of the nonlinear soft margin classifier comprises:
$${min}_{α} \frac{1}{2} {\sum }_{i = 1}^{l} {\sum }_{j = 1}^{l} {y}_{i} {y}_{j} {α}_{i} {α}_{j} K ( {x}_{i} , {x}_{j} ) - {\sum }_{j = 1}^{l} {α}_{j}$$
$$s . t . \text{:}$$
$${\sum }_{i = 1}^{l} {y}_{i} {α}_{i} = 0$$
$$0 \leq {α}_{i} \leq C , i = 1 , … , l .$$

10. The non-volatile computer storage medium according to claim 9, wherein the video identifying model determines a best value of the parameter σ and a best value of the penalty parameter C using k-fold cross validation, a number of k is 5, the penalty parameter C is set within a range of [0.01, 200], the parameter σ of the kernel function is set within a range of [1e-6, 4], and a step length of the parameter σ of the kernel function and a step length of the penalty parameter C both are 2.

11. An electronic apparatus, comprising:
at least one processor; and
a memory communicatively connected to the at least one processor; wherein,
the memory stores a program which could be processed by the at least one processor, the instruction is executed by the at least one processor so that the at least one processor is capable of:
acquiring a video sample to be identified;
extracting all of key frames of the video sample;
classifying the key frames of the video sample using a deep learning model; and
determining whether the video to be identified is a salacious video according to a classification result.

12. The electronic apparatus according to claim 11, wherein, the determining whether the video to be identified is the salacious video according to the classification result comprises:
determining the video to be identified is a non-figure video so that it is determined that the video to be identified is not the salacious video, if the classification result indicates that a number of the key frames of the video sample regarding human figure is less than a first threshold of a number of the key frames of the video sample.

13. The electronic apparatus according to claim 11, the determining whether the video to be identified is the salacious video according to the classification result comprises:
dimensionally reducing input characteristics of all the key frames of the video to be identified if the classification result indicates the number of the key frames of the video sample regarding human figure is greater than or equal to the first threshold of the number of the key frames of the video sample;
detecting each key frame of the video sample through the dimensionally reduced input characteristic of each key frame of the video sample and a video identifying model trained in advanced; and
determining the video to identified is the salacious video so that a warning label is provided, if a detection result indicates a number of the key frames of the video sample regarding salacity is greater than a second threshold of the number of the plurality of key frames of the video sample, otherwise, determining the video sample is not the salacious video.

14. The electronic apparatus according to claim 13, wherein the video identifying model is obtained by a support vector machine according to the input characteristic, and a formula corresponding to the video identifying model is expressed as:
$$f ( x ) = sgn ( {\sum }_{i = 1}^{l} {α}_{i}^{*} {y}_{i} K ( x , {x}_{i} ) + {b}^{*} ) ;$$
wherein
$${α}^{*} = {( {α}_{1}^{*} , … , {α}_{l}^{*} )}^{T} ;$$
$${b}^{*} = {y}_{j} - {\sum }_{i = 1}^{l} {y}_{i} {α}_{i}^{*} K ( {x}_{i} , {x}_{j} ) ;$$
a value of j is obtained by selecting a positive component 0<αⱼ*<C from αⱼ*, and K(xᵢ*xⱼ) represents a kernel function, wherein a formula corresponding to the kernel function is expressed as:
$$K ( {x}_{i} * {x}_{j} ) = exp ( - \frac{{‖ {x}_{i} - {x}_{j} ‖}^{2}}{2 {σ}^{2}} ) ;$$
an initial value of a parameter a of the kernel function is set as 1e-5;
wherein C is a penalty parameter, the initial value of C is 0.1, ε, represents a slack variable corresponding to the i^{th} video sample, xᵢ represents a sample characteristic parameter corresponding to the i^{th} video sample, yᵢ represents a type of the i^{th} video sample, xⱼ represents a sample characteristic parameter corresponding to the j^{th} video sample, yⱼ represents a type of the j^{th} video sample, the parameter a of the kernel function is an adjustable function, l represents total number of the video samples, the symbol “∥ ∥” represents a norm, and the formula corresponding to a nonlinear soft margin classifier is expressed as:
$${min}_{w , b} \frac{1}{2} {‖ w ‖}^{2} + c {\sum }_{i = 1}^{l} {ɛ}_{i} ;$$
subject to:
yᵢ((w×xᵢ+b))≧1−εᵢ,i=1, . . . , l
εᵢ≧0,i=1, . . . , l
C>0;
wherein the formula of a parameter w comprises:
$$w = {\sum }_{i = 1}^{l} {y}_{i} {α}_{i} {x}_{i} ;$$
a dual formula of the nonlinear soft margin classifier comprises:
$${min}_{α} \frac{1}{2} {\sum }_{i = 1}^{l} {\sum }_{j = 1}^{l} {y}_{i} {y}_{j} {α}_{i} {α}_{j} K ( {x}_{i} , {x}_{j} ) - {\sum }_{j = 1}^{l} {α}_{j}$$
$$s . t . \text{:}$$
$${\sum }_{i = 1}^{l} {y}_{i} {α}_{i} = 0$$
$$0 \leq {α}_{i} \leq C , i = 1 , … , l .$$

15. The electronic apparatus according to claim 14, wherein the video identifying model determines a best value of the parameter σ and a best value of the penalty parameter C using k-fold cross validation, a number of k is 5, the penalty parameter C is set within a range of [0.01, 200], the parameter σ of the kernel function is set within a range of [1e-6, 4], and a step length of the parameter σ of the kernel function and a step length of the penalty parameter C both are 2.
